(19) United States
(12) Patent Application Publication
(10) Pub. No.: US 2002/0001544 A1
(43) Pub. Date: Jan. 3, 2002

(54) System and method for high throughput processing of droplets

(76) Inventors: Robert Hess, Brighton, MA (US); Colin Brenan, Marblehead, MA (US); John Linton, Lincoln, MA (US); Can C. Ozbal, Cambridge, MA (US); Donald Green, Watertown, MA (US); Ian Hunter, Lincoln, MA (US)

Correspondence Address: BROMBERG & SUNSTEIN LLP, 125 SUMMER STREET, BOSTON, MA, 02110-1618, US

(21) Appl. No.: 09/842,361

(22) Filed: Apr. 25, 2001

Related U.S. Application Data
(63) Continuation-in-part of application No. 09/081,700, filed on May 20, 1998, now Pat. No. 6,309,600.
(60) Provisional application No. 60/057,734, filed on Aug. 28, 1997.

(51) Int. Cl. B01L 3/02; G01N 1/10

(52) U.S. Cl. 422/100; 436/180

(57) ABSTRACT

A method for high throughput processing of a plurality of droplets. The droplets are dispensed onto a moving surface and delayed in a delay line in which the droplets hang from the moving surface for at least a specified minimum period of time. A laminate may be spooled onto the moving surface and each droplet may be dispensed onto the laminate. At least one operation is performed on each droplet from the group of operations consisting of mixing, diluting, concentration, heating, cooling, humidifying, filtering, and analyzing. The laminate may then, in certain embodiments, be spooled off the moving surface, processed, and reused.

### PRIORITY

This application is a continuation-in-part of U.S. application Ser. No. 09/081,700, entitled “Apparatus and Method for Droplet Microchemistry”, having a filing date of Nov. 20, 2000, which is a continued prosecution of U.S. application Ser. No. 09/081,700, entitled “Apparatus and Method for Droplet Microchemistry” having a filing date of May 20, 1998, which claims priority from U.S. provisional application No. 60/057,734, filed Aug. 28, 1997, each of which is herein incorporated by reference.

### TECHNICAL FIELD

The present invention pertains to a system and method for dispensing, transporting, tracking, and analyzing a massive number of droplets of liquid, where the analyzing may include mass spectrometry and optical interrogation, such as fluorescence spectrometry, Raman spectroscopy, and UV absorption, and for performing microchemical operations on these droplets, the operations including mixing, dilution, concentration, heating, cooling, and filtering.

### BACKGROUND OF THE INVENTION

Chemistry on the micro-scale, involving the reaction and subsequent analysis of quantities of reagents or analytes of order microliters or smaller, is an increasingly important aspect of the development of new substances in the pharmaceutical and other industries (e.g., synthesis and analysis of new conductive polymers, phosphors, superconductors, etc.). Such reaction and analysis must accommodate vast libraries of compounds to be reacted and analyzed under various conditions.

Significant problems associated with current technologies dealing with chemical analysis of vast numbers of compounds (potentially on the order of hundreds of thousands or millions per day) include the problem of tracking and identifying each droplet as it moves through a high throughput processing system. Furthermore, the surface upon which the droplets are dispensed is typically unsuitable or not optimized for high throughput processing of droplets. These surface properties, include, but are not limited, to cleanliness, biocompatibility, surface energy, binding affinity, porosity, chemical interaction, chemical addition, sample information encoding, and tracking. Additionally, the processing of the droplets may necessitate transporting droplets through a controlled environment for large periods of time.

### SUMMARY OF INVENTION

In accordance with one embodiment of the invention, a method and system are provided for high throughput processing of a plurality of droplets. The method includes dispensing the plurality of droplets onto a substantially unperforated surface. The surface is moved through a delay line such that each droplet hangs from the surface for at least a period of time, the droplet adhering to the surface by virtue, at least in part, of surface attraction.

In further related embodiments, the step of dispensing each droplet includes limiting each droplet to a specified volume smaller than one microliter. Each droplet may be dispensed onto the surface while the surface is moving. Motion of the surface may be delayed through a delay line. Delaying the motion may include moving the surface via a pulley system, or moving the surface around a drum. Delaying the motion may include hanging each droplet beneath the surface, exposing each droplet to a controlled environment, and analyzing a characteristic of each droplet.

In accordance with another embodiment of the invention, a method and system for high throughput processing of a plurality of droplets includes dispensing each droplet onto a moving surface and tracking each droplet's position. The moving surface may move continuously or in a discontinuous start/stop action. One or more microtiter plates may be provided to a microtiter plate handling system. Data is provided that identifies each microtiter plate's position to the microtiter plate handling system. The microtiter plate handling system is then commanded to retrieve a particular microtiter plate, the particular plate presented by the microtiter plate handling system for dispensing. Each droplet's position may be measured and recorded on the moving surface using a position sensor, such that each droplet is associated with a fiducial position on the moving surface. The position sensor may be a rotary encoder. Each droplet's position on the moving surface may be measured and recorded at substantially the same time each droplet is dispensed onto the moving surface. Each droplet's position may be saved in random-access memory. Each droplet may be detected using a drop sensor, the drop sensor at a known position relative to the position sensor. The known position is then verified with each droplet's position based on the fiducial position and position information obtained from the position sensor at each droplet's time of detection. The drop sensor may be located at an interface to an analyzer, substrate station, or a reactant station. A failure may be recorded if the known position does not correspond to each droplet's position based on the fiducial position and position information obtained from the position sensor at time of detection. A particular droplet may be dispensed onto the moving surface with known analytical properties. The particular droplet's position and identity can then be verified by analyzing the particular droplet at a known position relative to the fiducial position so as to obtain analyzed properties; comparing the particular droplet's analyzed properties with the particular droplet's known analytical properties; and comparing the known position against the particular droplet's position as derived from the position sensor.

In additional related embodiments, each droplet may be subjected to a controlled environment, which may include hanging the droplet from the moving surface for at least a specified minimum period of time, the droplet adhering to the moving surface through, at least in part, surface attraction. Each droplet may be transported, via the moving surface, through an environmentally controlled delay line.

In other related embodiments, at least one operation may be performed on each droplet from the group of operations consisting of mixing, diluting, concentrating, filtering, and analyzing. Analyzing may include performing at least one operation from the group of operations consisting of optical interrogation and mass spectrometry. Optical interrogation may include at least one of fluorescence spectrometry, Raman spectroscopy and UV absorption. Analyzing the content of each droplet may include aspirating each droplet into a dispensing unit and presenting each droplet for analysis via the dispensing unit. Each droplet may be presented to a mass spectrometer and a characteristic of each droplet determined by means of mass spectrometry. Analyzing a characteristic of each droplet may include heating each droplet, or applying a pneumatic or explosive force to each droplet, so as to form an atomized spray and determining a characteristic each droplet by means of mass spectrometry. Each droplet may be vibrated so as to cause atomization, whereupon a characteristic of each droplet can be determined by means of mass spectrometry. Vibrating the droplet may include focusing a pulsed laser onto the surface or backside of the surface in a proximity of each droplet, utilizing acoustic waves, or mechanically vibrating the surface. A voltage to the surface onto which each droplet is deposited may be applied to assist in the formation of atomized spray.

In further related embodiments, the moving surface may be a conveyor belt, fiber, or timing belt. The moving surface may be unperforated. A laminate may be applied to the moving surface prior to dispensing each droplet onto the moving surface. In various embodiments, the laminate is spooled onto the moving surface, whereupon at least one operation may be performed on each droplet. The laminate may then be spooled off of the moving surface. At least one surface property of the laminate may be customized from the group of surface properties consisting of cleanliness, biocompatibility, surface energy, binding affinity, porosity, chemical interaction, chemical addition, sample information encoding, and tracking. Each droplet may have a specified volume smaller than one microliter.

In another embodiment of the invention, a method and system of high throughput processing of a plurality of droplets includes hanging each droplet from a dispenser. Each droplet is brought into momentary contact with a moving surface having a probe, such that each droplet is deposited onto the probe through surface attraction. An alternating current is applied to the probe so as to cause the probe to vibrate such that each droplet is atomized and a characteristic of each droplet analyzed.

In yet another embodiment of the invention, a method and system of high throughput processing of a plurality of droplets includes dispensing each droplet into an enclosed volume, the enclosed volume having an exit channel, the enclosed volume incorporated into a moving conveyer. Each droplet is heated in the enclosed volume such that the expansion of the droplet causes it to be ejected through the exit channel in the form of an atomized spray. The characteristics of the atomized spray are then analyzed by means of mass spectrometry.

In another embodiment of the invention, a method and system for high throughput screening of a plurality of droplets includes spooling a laminate onto a moving surface. Each droplet is dispensed onto the laminate. At least one operation is performed on each droplet from the group of operations consisting of mixing, diluting, concentration, heating, cooling, humidifying, filtering, and analyzing. The laminate may then be spooled off the moving surface.

In related embodiments, the step of spooling may include depositing the laminate onto a conveyor belt. The method and system may further include cleaning the laminate and repeating the steps of spooling the laminate onto the moving surface, dispensing, performing on each droplet at least one operation, and spooling the laminate off the moving surface. The laminate may be disposed of after use. At least one surface property of the laminate may be customized from the group of surface properties consisting of cleanliness, biocompatibility, surface energy, binding affinity, porosity, chemical interaction, chemical addition, sample information encoding, and tracking. The laminate may be magnetic and the droplet may include magnetized particles. Each droplet may be to a controlled environment. At least one droplet in the controlled environment may hang from the laminate for at least a specified minimum period of time, the droplet adhering to the laminate through, at least in part, surface tension. Each droplet on the laminate may be transported, by virtue of motion of the movable surface, through an environmentally controlled delay line prior to performing the at least one operation on each droplet. The moving surface may be a timing belt. The moving surface may move continuously or in a discontinuous start/stop action. The laminate surface may be unperforated. Analyzing may include performing at least one operation from the group of operations consisting of optical interrogation and mass spectrometry. Optical interrogation may include applying at least one of fluorescence spectrometry, Raman spectroscopy and UV absorption. Analyzing may also includes hanging each droplet from the laminate for at least some period of time, the droplet adhering to the laminate through, at least in part, surface tension. Each droplet may be tracked on the moving surface.

In yet another embodiment of the invention, a method and system for high throughput processing of a plurality of droplets includes dispensing a plurality of droplets onto a substantially unperforated surface. The surface is then moved through a delay line such that each droplet hangs from the surface for at least a period of time, wherein the force acting to counter gravity is predominantly non-shearing.

### BRIEF DESCRIPTION OF THE DRAWINGS

The invention will be more readily understood by reference to the following description, taken with the accompanying drawings, in which:

FIG. 1 is a schematic of a high throughput screening system according to one embodiment of the present invention;

FIG. 2 is a schematic of a wound tape with through holes in accordance with one embodiment of the present invention;

FIG. 3 is a schematic of a system for dispensing droplets on a tape with through holes in accordance with one embodiment of the present invention;

FIG. 4 is a schematic of a system for transferring fluid from a pin array to through holes on a wound tape in accordance with one embodiment of the present invention;

FIG. 5 is a schematic of a front view of a syringe bank in accordance with one embodiment of the present invention;

FIG. 6 is a schematic of a side view of a syringe bank in accordance with one embodiment of the present invention;

FIG. 7 is a schematic of a top view of a syringe bank in accordance with one embodiment of the present invention;

FIG. 8 is a schematic showing a humidification scheme for droplets on a moving surface in accordance with one embodiment of the present invention;

FIG. 9 is a schematic of a valve assemble that removes the sample to be interrogated from the moving surface by aspiration in accordance with one embodiment of the present invention;

FIG. 10 is a schematic of the valve assembly of FIG. 10 when the sample is being aspirated in accordance with one embodiment of the present invention;

FIG. 11 is a schematic of the valve assembly of FIG. 10 when the sample is being presented for mass spectrometry in accordance with one embodiment of the present invention;

FIG. 12 is a schematic of a piezo-electric unit assembly that removes the sample to be interrogated from the moving surface by aspiration in accordance with one embodiment of the present invention;

FIG. 13 is a schematic of a piezo-electric unit assembly dispensing a sample in a stream of very small droplets towards the inlet of a mass spectrometer in accordance with one embodiment of the present invention;

FIG. 14 is a schematic of a piezo-electric unit assembly dispensing a sample in the form of a stream of micro-droplets to a surface proximal to the inlet surface of a mass spectrometer in accordance with one embodiment of the present invention;

FIG. 15 is a schematic of a piezo-electric unit assembly dispensing a sample in the form of a high speed stream of micro-droplets at the point of a sharp pin or needle towards the inlet of a mass spectrometer in accordance with one embodiment of the present invention;

FIG. 16 is a schematic of a piezo-electric unit assembly dispensing a sample in the form of a high speed stream of micro-droplets at a fine mesh towards the inlet of a mass spectrometer in accordance with one embodiment of the present invention;

FIG. 17 is a schematic of a piezo-electric assembly dispensing a sample in the form of a high speed stream of micro-droplets at a hole in a parabolic mirror towards the inlet of a mass spectrometer, the stream being collinear with a light beam from a laser, in accordance with one embodiment of the present invention;

FIG. 18 is a schematic of a system for rapidly heating samples on a moving surface so as to cause atomization in accordance with one embodiment of the present invention;

FIG. 19 is a schematic of a system for forcibly ejecting a sample from a moving surface in accordance with one embodiment of the present invention;

FIG. 20 is a schematic of a system for rapidly vibrating samples on a moving surface so as to cause atomization in accordance with one embodiment of the present invention; and

FIG. 21 is a schematic of a system for rapidly vibrating samples on a moving surface so as to cause atomization using a vibrating probe, in accordance with one embodiment of the invention.

### DETAILED DESCRIPTION

Various methods and systems for the high throughput processing of a plurality of droplets are presented. A droplet may be referred to herein and in the appended claims as a “microdroplet” or a “sample,” and may include droplets containing living cells, such as yeast cells, for example, and may, more particularly, include droplets carrying a single living cell per droplet.

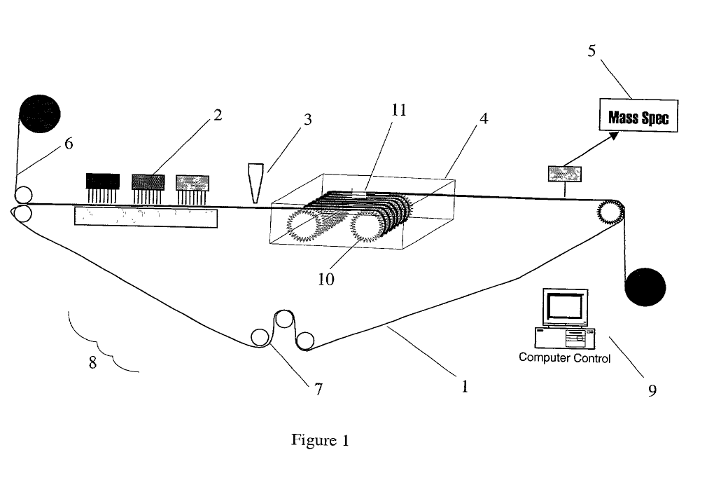

FIG. 1 is a schematic of a high throughput processing system 8 according to one embodiment of the invention. The system includes a moving surface 1, a compound reformatter 2, a reagent addition station 3, an environmental delay chamber 4, computer control 9, and at least one analyzer, such as a mass spectrometer 5, for example. Each of these elements in the system will now be covered in detail.

The Moving Surface

As shown in FIG. 1, moving surface 1 connects various components of the high throughput screening system 8 together. Moving surface 1 may be a belt, tape, conveyor, or web, which, while used interchangeably throughout this document, may advantageously be chosen for particular applications. While the moving surface 1 may simply act as a transport mechanism, in preferred embodiments of the invention, the moving surface 1 also plays an active part in the assay physics or chemistry, such as binding, separation, or filtration. The moving surface 1 may be a simple one-layer film that is driven by friction, or it can be a multilayer composite with a surface specifically designed for a specified assay to be performed. Additionally, moving surface 1 can take the form of a fiber. In a preferred embodiment of the invention, moving surface 1 is similar to a timing belt with teeth for engagement by a sprocket such that accurate and robust positioning of the belt is facilitated. Moving surface 1 may move continuously, or with a discontinuous start/stop action.

While moving surface 1 may be of fixed length, being unwound from an unwind station as required, and with splices employed when more length is required, moving surface 1 may also be joined end to end, as shown in FIG. 1. In this manner, splices are not required when additional length is needed, and uniform tensioning is facilitated.

In order to provide a surface that is optimized for the assay in question, in various embodiments of the invention moving surface 1 is designed such that the top surface is physically, chemically, or biologically active. Alternatively, the surface can be prepared online, such as by corona treatment.

In a preferred embodiment of the invention, a laminate 6, which may be a tape, is applied to the moving surface 1. Laminate 6 may be permanently bonded to moving surface 1. Alternatively, laminate 6 may be attached temporarily to the moving surface 1 for removal at a later time. In a preferred embodiment, as shown in FIG. 1, a tape 6 is spooled to the top surface of a moving belt 1, and removed and rewound after analysis is complete. In this manner, a new assay surface can be applied and removed after use. After removal, the laminate may either be cleaned and reused, or disposed of. This may be advantageous for several reasons, including, but not limited to, allowing the top surface of moving surface 1 to be easily and quickly customized for each assay performed. To remove any static charge build up on the moving surface during the lamination process, which may cause droplets dispensed from a syringe bank 2 to jump instead of being dispensing in a desired pattern, an antistatic gun or ionizer may be used. One such ionizer ionizes the air using alpha particles, for example. In preferred embodiments of the invention, the ionizer is placed in proximity to the belt, after the lamination and before the dispensing stations.

Laminate 6 can be customized for numerous surface properties (as can the moving surface 1 if no laminate is applied). These properties include, but are not limited to, cleanliness, biocompatibility, surface energy, binding affinity, separation, porosity, chemical addition and interaction, sample information encoding and tracking, and the addition of surface features.

Cleanliness and Biocompatability

Surface cleanliness and biocompatibility are critical for assay quality. Laminate 6 may include a biocompatible surface such as, but not limited to, Teflon, polypropylene, or polyethylene. Furthermore, the surface of laminate 6 can be such that it is easily washable after application. This is important if the active face of laminate 6 is contaminated as received or if it is to be recycled through the assay system.

Surface Energy

In accordance with various embodiments of the invention, the surface of laminate 6 is chosen to have a low surface energy to localize the aqueous sample drops and minimize spreading, or a high surface energy to maximize spreading and contact with the tape. ‘Surface energy,’ in this context, refers to wettability. Additionally, the surface of laminate 6 may have a uniform surface energy, or a pattern of surface energies such as hydrophilic spots on a hydrophobic background that serves to promote drop adhesion as well as minimize drop migration. This pattern can be pre-existing on the surface of the laminate 6, or applied to the surface inline, such as by lamination or by localized corona discharge devices. Applying the pattern inline obviates the need for pre-registering the laminate 6 with the drop placement, as the surface energy pattern is applied in a pattern registered with the drop dispensing.

Binding

The surface of the laminate 6 may be prepared, either uniformly or spatially distributed, with a surface that binds, selectively or non-selectively, to molecules in the assay sample. In this manner, heterogeneous processes such as washing or Fluorescence In-Situ Hybridization (FISH) can be performed. For example, washing can be accomplished by passing the laminate 6 through a wash bath and removing the unbound components of the droplet. Sample coatings that can be used and that are known in the art include streptavidin and biotin.

Separation

In various embodiments of the invention, laminate 6 is magnetic, either by being magnetic material or by passing over a magnet, to allow the use of magnetic bio-separation beads or other devices. The beads can be added to the droplet to bind molecules of interest, which then attach to the laminate through magnetic interaction. The droplet can then be washed, in a bath or otherwise, with the beads and molecules of interest still fastened to their original location on laminate 6. The use of a flexible magnetic strip may be advantageously used as a magnetic surface for laminate 6. The strip is made up of tiny individual magnets dispersed in a polymeric binder. This provides magnetic flux gradients that capture the beads in place, whereas a uniformly magnetized surface would capture the beads but allow them to migrate on the surface across the uniform magnetic field. The flexible magnetic strip may be permanently magnetized, such as the “refrigerator magnet” type strip, or be temporarily magnetized, such as high quality metal particle recording media. The flexible magnetic strip also has the advantage that sample information can be written next to the sample droplet on the tape for later identification or to facilitate analysis.

Porosity

In another embodiment of the invention, either the entire surface, or part of laminate 6 is made porous. This increases the contact area of the droplet with the derivatized surface, so as to minimize the exposure the droplet has with the atmosphere, or for filtration. The pores can be through the depth of the tape, or only a fraction thereof. The pores can be isotropic or anisotropic. In one embodiment of the invention, the pores of laminate 6 are oriented perpendicular to the surface and travel only a fraction of the film thickness. The allows sample penetration beneath the surface while minimizing sample spreading.

Chemical Addition

In accordance with one embodiment of the invention, the surface of the laminate 6 can be prepared uniformly or in a spatially patterned manner with one or more chemicals designed to participate either chemically or physically in the assay.

For example, laminate 6 can be coated with a surfactant such that upon addition of the sample, the surfactant diffuses to the surface of the sample drop to help retard evaporation. Suitable materials for this example include, but are not limited to, fatty acids and fatty alcohols such as dodecanol.

Other examples include, but are not limited to, coating laminate 6 with a MALDI matrix to enable the ionization of the sample components or their reaction products, or coating laminate 6 with Ion-exchange resin or with affinity-labeled sepharose beads.

Surface Features

The surface of the laminate 6 may incorporate surface features such as cups or indentations, tube holders, holes, and funnels. Another laminate 6 may also be applied to the surface, in particular, a surface with cups, to act as a lid to prevent sample contamination and provide environmental control.

An efficient high throughput screening system 8 requires physical operations to be performed both in a serial (time sequential) and parallel manner. As is known in the art, a two-dimensional array of through holes can be rapidly loaded in parallel by dipping the array into a bulk solution. Additionally, reactions can be initiated in parallel by stacking two co-registered through-hole arrays one on top of the other. However, the loading and removal of fluids from different through holes in the array is fundamentally a serial process, and the time required to accelerate and de-accelerate a through hole array relative to a dispensing or aspirating tube requires an undue amount of time. Accordingly, moving surface 1 may advantageously take the form of a two-dimensional array when wound, and a one-dimensional array when unwound. Fluids can then be dispensed or removed from the one-dimensional array in a time-sequential (serial) manner, and when desired, the one-dimension array can be reconfigured into a two dimensional array for storage or to conduct parallel operations, such as dip loading, mixing, and optical-based read-out. Additional serial operations, include, but are not limited to, interfacing to an inherently serial analyzer (e.g. mass spectrometer) or interfacing to a compound library stored in microtiter plates.

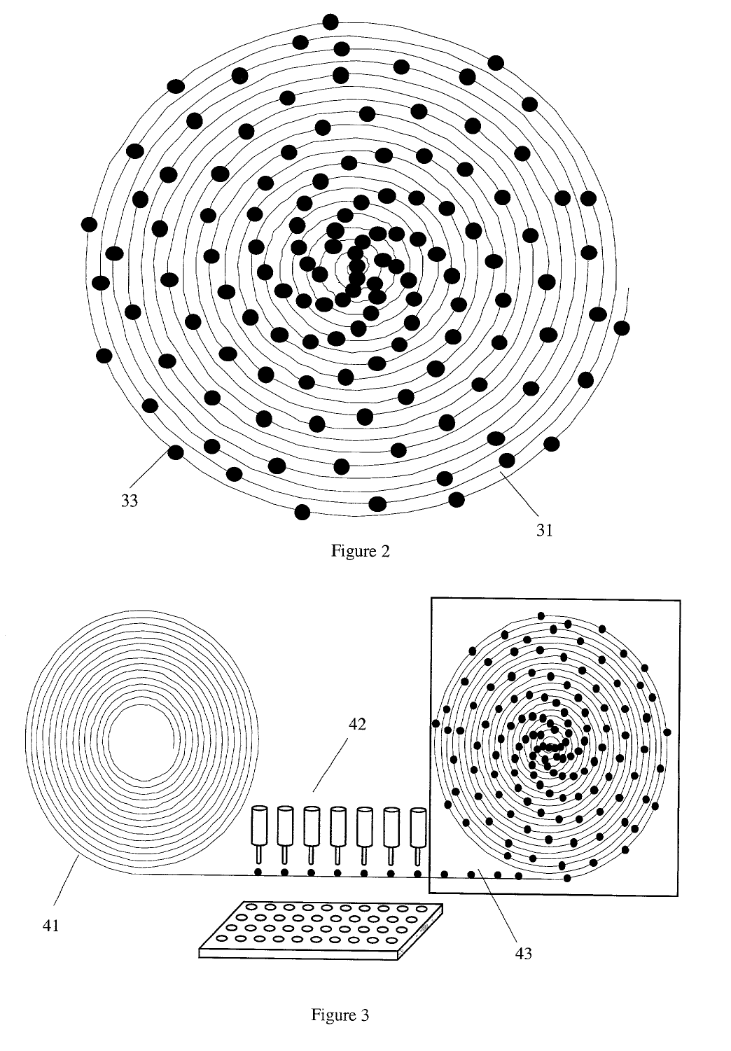

In accordance with one embodiment of the invention, moving surface 1 and/or laminate 6 (hereinafter laminate shall be used for this embodiment) can be wound, as a spiral for example, and unwound, acting as an improved microtiter plate. Laminate 6 may be, but is not limited to, a tape, fiber, or belt. The laminate 31 includes through holes 33 perpendicular to its width, which serve as containers to hold sub-microliter volumes of fluid, as shown in FIG. 2. Through holes 33 may be machined into the surface, (for example formed from the surface geometry itself, or capillary tubes may be attached at intervals along the length of the surface. Through hole containers 33 are preferably at equally spaced intervals along the length of the surface. Laminate 31 may be wound such that the through holes 33 are perpendicular to the plane of the tape and the through-holes 33 form a known geometric pattern. In a preferred embodiment the through-hole 33 center-to-center spacing is an integral multiple of the well-to-well spacing in a 96-, 384- or 1536-well microtiter plate. Compounds stored as fluids in a microtiter plate are transferred into through-holes 33 by a bank of syringes having a center-to-center spacing an integral multiple of the well spacing in the plate. As shown in FIG. 3, the laminate 41 is unwound and passed beneath the syringe dispensing head 42, whereupon known amounts of fluid are dispensed into each through-hole 43 and laminate 41 is advanced. With two syringe banks and simple automation, fluids can be transferred and loaded into laminate 41 through holes 43 at a rate exceeding one compound per second. Instead of syringes, pins or quills may also be used for the fluid transfer. After fluid loading, laminate 41 may be spooled in a temperature and humidity-controlled chamber to minimize evaporation of the loaded fluids. The high aspect ratio of through-holes 43 serves to slow fluid loss from evaporation because of the small surface area-to-volume ratio.

As shown in FIG. 4, once a compound library is loaded, a two-dimensional array of pins 51 having the same two-dimensional geometry and center-to-center spacing of the through-holes 52 may be dip loaded with reagent, co-registered with respect to the laminate through-hole array 53 and brought into proximity of through-holes 52 such that fluids are transferred from the pins to through-hole 52. In this manner, reagents are loaded and reactions initiated simultaneously in a massively parallel manner. Cells may also be placed in the through holes and cell-based assays performed. The laminate through-hole array 53 may be placed in a temperature and humidity-controlled environment for a prescribed length of time after which a stop reagent is added to through-holes 52 in a manner similar to the addition of the reaction reagents. The laminate through-hole array 53 is unwound and the reaction products in each through-hole 52 are sampled and analyzed, for example, by being injected sequentially into a mass spectrometer for analysis. Additionally, if the assay read-out is optical-based then each through-hole 52 is optically analyzed in parallel (i.e. imaged) and then read-out sequentially with the mass spectrometer.

The Compound Reformatter

In accordance with one embodiment of the invention, the library compounds to be screened are reformatted from the plates to the surface of the moving surface by a compound reformatter 2, as shown in FIG. 1. Reformatter 2 may include a robotic arm that selects a plate from a storage system and places it within access of the moving surface 1 in a defined location. A microsyringe or a bank of microsyringes on a xyz stage transfers a sample compound from a well to the surface of the tape 6. In addition to microsyringes, piezo or bubble jet heads, quills or pins may be used to transfer samples to the tape. Repeating this operation results in an array of drops on the moving tape 6. Because the rate of movement of the tape 6 and/or its position is accurately known, the position and identification of the drop is known, and subsequent reagent additions and analysis can be performed on specific drops later in the high throughput process. The drops are spatially isolated from each other on the tape so that no cross contamination can occur. Preferably, the drops are 1·l or less to minimize compound usage and so that surface tension forces exceed gravitational forces and the drops stick to the tape 6 regardless of its orientation.

In a preferred embodiment of the invention, a bank of microsyringes is used instead of one microsyringe. For example, 8 or 12 microsyringes in a row with 9 mm tip-to-tip spacing in a bank can be used to facilitate transfer from commercial 96 and 384-well microtiter plates. A multipipettor approach may be advantageously utilized because it creates time between dispensings that can be used for washing the pipettes and transporting the microtiter plates.

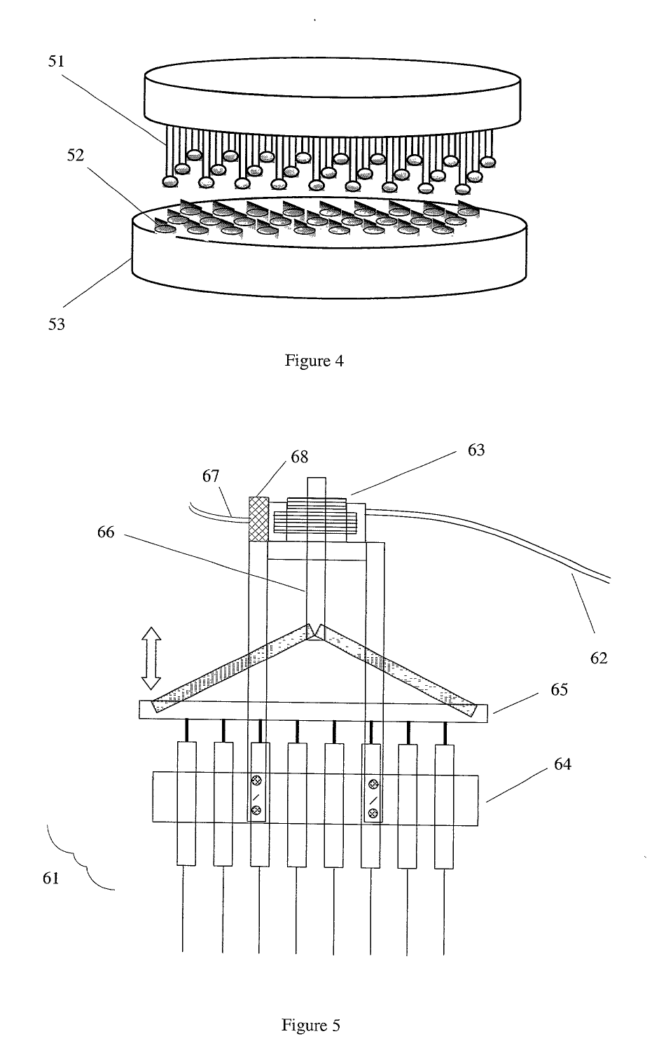

FIGS. 5, 6, and 7 show a front view, side view, and top view, respectively, of a syringe bank system 61 in accordance with one embodiment of the invention. A flexible coupling 62 or linkage transmits torque to the plunger drive gear 63, allowing the torque source, which may be a stepper or servo motor, to be remotely mounted. This greatly reduces the mass of the syringe bank assembly 64 when compared to a design that incorporates the motor onboard. Consequently, the overall assembly has little inertia relative to current designs and therefore requires less power to accelerate when attached to a positioning system. Greater accelerations can also be achieved for a given amount of applied force.

In various embodiments of the invention, a rack and pinion gearing 63 system is used to transform the rotary motion supplied to the syringe assembly 64 by the motor and coupling into a linear motion, which would then drive the syringe plungers in and out. To combat backlash error a pair of racks attached to the plunger assembly 65 may be used. By mounting the rack gear pieces 66 slightly translated in the direction of their length with respect to each other backlash between the drive pinion 63 and plunger rack 66 may be ‘taken up’ at assembly time.

An alternative gearing scheme could be incorporated such as a worm gear driving a threaded rod. The plunger bar 65 would be driven by either threading the rod through a part of the plunger assembly or rigidly attaching the threaded rod to the plunger assembly 65 and threading the rod through the center of the worm gear. Either scheme requires mechanically constraining the plunger assembly to vertical translations. A worm gear configuration allows for a higher over all gear ratio to be achieved between the drive system 63 and the plunger assembly 64. It also has the virtue of being un-back drivable, that is, the plunger assembly 64 would be self-locking and no torque would be required to hold the plunger assembly 64 in place.

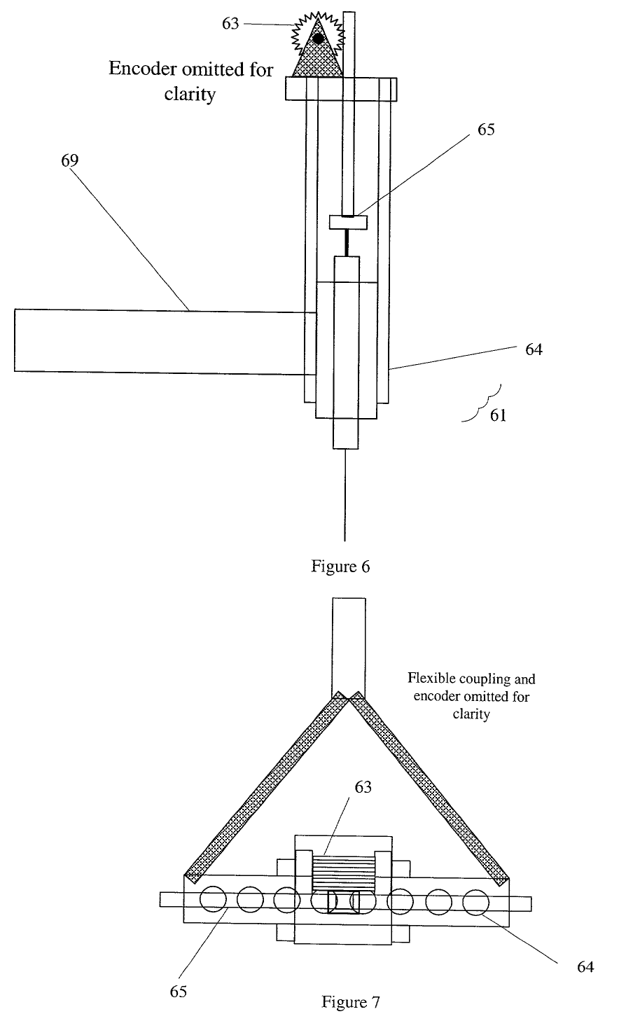

In other embodiments of the invention, a rotary encoder 68 that is controlled externally 67 is attached to the drive gear axis 63 that drives the plunger assembly 64. By using rotary encoder 68, precise metering of the fluid can be achieved as it dispensed from the syringes. Additionally, a connector bar 69 may be used to position the syringe bank system 61, as shown in FIG. 6.

The syringe bank component is modularized such that one may choose various methods of translating the syringe bank from the microtiter plates to the laminate. One possible configuration would be a 2-axis gantry that allows precise positioning in a plane. Additionally, in various embodiments of the invention, two syringe banks on a gantry could be utilized such that one bank could be collecting samples from a plate and dispensing while the other bank is being washed.

Reagent Addition Station(s)

In accordance with one embodiment of the invention, one or more reagent addition stations 3, as shown in FIG. 1, can be placed anywhere along the moving surface 1, but are typically placed downline of the Compound Reformatter 2. Reagents may consist of buffers, reactant, substrates, beads, solids, slurries or gels. The reagents may be dispensed in drops by coordinating the timing of the dispensing with control of the moving surface 1 such that they are added to the same positions as other drops, thus causing reagents to mix and form a single, larger drop. Mixing occurs while each drop-holding domain remains spatially isolated from one another, each drop being a separate assay reaction. Reagent addition station(s) 3 may consist of a single microsyringe, an array of microsyringes as described above, or a piezo dispensing head that has a reservoir of reagent.

In various embodiments of the invention, a solid-phase synthesis is performed on laminate 6. Analysis of desired properties can then be performed immediately, or laminate 6 may be rolled up and stored as a spool or cassette. Typically, to perform solid phase synthesis, a linker molecule is strongly attached to a solid support and presents a potentially reactive species to a reagent containing liquid that is contacted with the solid support. The linker may be attached directly to laminate 6, to pores in laminate 6, or to particles or gels attached to laminate 6. As laminate 6 advances past various dispensing stations, reagents may be added to accomplish chemical synthesis. If each station is capable of dispensing more than one type of reagent, a combinatorial synthesis may be accomplished. Such a combinatorial synthesis would be under control of a computer 9 that would create the pattern of chemical additions to create a useful chemical diversity. Reagents that may be added include any reagents typically used in a chemical synthesis including, but not limited to: monomers, catalysts, activators, blocking agents, de-blocking agents or polymers. Standard methods of synthesis of biopolymers such as peptide, nucleic acids and carbohydrates may be used. After synthesis, the product may be liberated from the surface of laminate 6 or other support by standard means such as the use of a chemically or photolabile linker. The properties of molecules synthesized may be determined by the output of functional assays performed directly on laminate 6.

Additionally, many types of chemical assays require sample preparation and cleanup prior to chemical analysis. This cleanup can range from relatively simple operations such as desalting or complex procedures such as the removal of contaminants, impurities, or excess reagents. A common method for sample clean up and preparation is the use of solid-liquid extraction using an insoluble matrix with appropriate chemistry. Types of insoluble matrices may include beads or gels of an insoluble material such as sepharose, silica, cellulose, or polymeric matrices. The insoluble phases may or may not have a surface coating that may be of hydrophobic, hydrophilic, or ionic character depending on the necessary application. Additionally, the insoluble matrix may be conjugated to or incorporate a paramagnetic particle (eg: iron oxide). In accordance with one embodiment of the invention, sample clean-up and preparation prior to or as part of a chemical reaction or analysis is performed on laminate 6. The appropriate insoluble matrix is added to the sample at one or more positions along the surface of laminate 6 in the form of a slurry or suspension. Sample impurities such as salts or other contaminants will then selectively bind to the insoluble matrix. In various embodiments of the invention, the impurities can be removed from the sample by allowing the matrix to settle onto laminate 6 while the liquid phase is interrogated with spectroscopic or spectrometric chemical analysis. Alternatively, the insoluble phase is conjugated to a paramagnetic bead that can then be selectively removed from the sample with the application of a magnetic field. In another embodiment of the invention, the sample of interest selectively binds the insoluble phase that incorporates a paramagnetic particle, while salts or impurities remain in the liquid phase. The insoluble phase with the adsorbed sample can be immobilized to laminate 6 with the application of a magnetic field. The liquid phase containing salts or contaminants can then be aspirated off of laminate 6 and the sample can be washed with an appropriate buffer or chemical. Finally, the sample can be desorbed from the immobilized matrix with the addition of yet another buffer of the appropriate type. Desorption of the sample from the insoluble matrix may include the addition of a variety of organic solvents or buffers with appropriate ionic strength, heating or cooling the sample, photochemistry, electrochemistry, or combinations of these methods.

Environmental/Delay Line/Incubation Chamber and Evaporation Control

In accordance with another embodiment of the invention, the droplet may be transported, via the moving surface/laminate, through a controlled environment prior to analysis, as shown in FIG. 1. In various embodiments of the invention, the environmental chamber 2 includes an environmentally controlled delay line 11, in order to allow various reactions being performed on the moving surface a given length of time before being assayed. The controlled delay line 11 may include an enclosed pulley system 10, such that the moving surface 1 travels back and forth in the environmental chamber 2. Alternatively, the controlled delay line 11 may include a drum that rotates, such that the moving surface 1 travels around the drum in the environmental chamber. The advantage of a delay line 11 comprising a pulley system or drum is that the delay line becomes much more compact than if it were implemented in a linear, elongated conformation. In various embodiments of the invention, the system requires that the drop be held at least in part by surface tension while it hangs for at least some specified period of time at various angles, such as beneath the surface or on its side, during the time it spends on the pulley or drum. In an alternate embodiment, a pulley system is wound such that the belt traverses a path that is horizontal with the pulleys rotating around a vertical axis and the droplets are suspended on the top or bottom of the belt or laminate. In this case, the droplet will tend to slide due to momentum at each turn of the pulley system. Another embodiment includes moving the surface in a spiral configuration, such that the droplets never hang, again momentum becomes an issue. In each of these embodiments, the parameters of droplet size and the energy of the surface interaction between the droplet and the surface of the tape or laminated tape must be chosen such that the droplet is not lost due to gravity and/or momentum. The interaction energy is determined by the material chosen for the surface and the chemical components of the droplet. The droplets may be allowed to slide slightly while being suspended from the side, but not so much that sliding would cause mixing of two or more drops, unless such mixing was desired. If droplets slide slightly during their vertical motion on a drum or pulley system, they will tend to slide an equal amount in the opposite direction on the next half turn of the pulley or drum, thus putting them approximately back where they began prior to the first instance of sliding.

Due to the propensity of aqueous microdroplets to evaporate, resulting in changes in concentration of analytes and reagents, various measures may be implemented to limit evaporation. At the same time, temperature must be controlled for consistent and optimal chemical, biochemical or biological reactions.

One means of preventing evaporative loss is to keep those parts of laminate 6 that contain desired microdroplets in a humidified environment, since drops having fluid volumes several microliters or less evaporate rapidly when in a low humidity environment. The relative humidity necessary depends on the size of the microdroplets and the incubation time for the assay, but can be greater than 95%. Humid air may be actively pumped into a substantially sealed environment surrounding the moving surface. A water reservoir may also be placed inside of the sealed environment. Temperature may be controlled by heating either the air in the sealed environment, the moving surface 1 and/or laminate 6 itself, or the water vapor being pumped in. Heat may be applied by various means including resistive heating, infrared light, or microwave radiation.

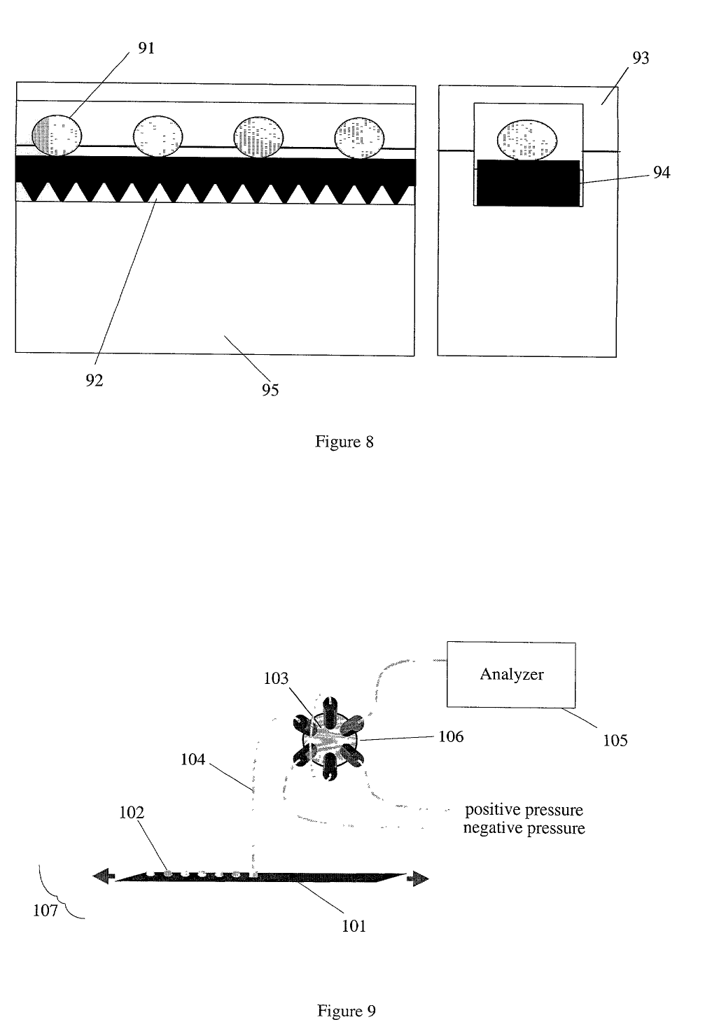

In accordance with one embodiment of the invention, a method to maintain a high humidity environment during droplet transport takes advantage of a mechanical guide that laterally constrains the belt, as shown in FIG. 8. The belt 94 moves on a support block 95 fits in a groove whose depth is approximately three-quarters the belt thickness. An enclosure 93 consisting of a metal plate with a machined groove fits on top enclosing a volume through which a droplet 91 on the belt's 94 surface is moved. To prevent drop evaporation during transport, the enclosed volume needs to be kept at a constant and high humidity. The groove through which belt 94 moves is partially filled with water 92. As water 92 evaporates, the water vapor fills the enclosure volume to keep the relative humidity high and constant. Water 92 can be readily injected at one end and transported the length of the groove by the relative friction between belt 94 and water 92 and the mechanical action of the transverse grooves on the bottom side of belt 94.

In another embodiment of the invention, the rate of evaporation is reduced by coating the droplets with a substance to limit evaporation. For example, by adding dodecanol or a similar surfactant, a hydrophobic barrier is formed on the outside of the drop to prevent evaporation.

In alternative embodiments of the invention, certain reagents that are extremely hydrophilic may be added to the droplet to limit evaporation. These include polymers such as polyethylene glycol, gels such as agarose, and small molecules such as glucose.

The design of the laminate may incorporate features to limit evaporation. The laminate may contain recessed areas, divots or through-holes that reduce the exposed surface area of the droplets. If the laminate is designed so that the drops do not extend past the surface of the laminate, the laminate may be sealed, such as by lamination with a water impermeable material, or covered with a hydrophobic liquid such as octane, decane, dodecane, mineral oil or silicone oil. The hydrophobic liquid should be chosen such that it is sufficiently non-volatile at the working temperature and that desired molecules in the microdroplet do not partition into it. To further limit evaporation of the microdroplets as they are being placed on the laminate, the dispensing heads of the sample delivery devices such as syringe banks may penetrate narrow slots, holes or septa in a humidified track.

In various embodiments of the invention, it is advantageous to control the amount of time a reaction is allowed to proceed before the drop is assayed. This can be done in four ways. The first is by sampling at different locations in the incubation chamber. The close proximity and regular spacing of the tape loops in the incubation chamber permits scanning of the drops at different times by moving the detector from loop to loop or by using multiple detectors.

Secondly, a variable path length delay line may be used to vary the sample residence time in the chamber. This can be achieved by moving a bank of pulleys, or by the use of festoons or dancers.

A third method for varying reaction times is by stopping the reactions at various points in the incubation chamber. For example, a series of eight identical reactions could be placed on the moving surface/laminate in order. A stop solution (a solution that stops the reaction from proceeding) can be added to each drop at different locations in the chamber, resulting in different times of reaction. Then the drops can be assayed as the tape leaves the chamber, and kinetic rate constants can be obtained from the data.

The fourth method is to add a reaction “start” solution to the drops at different places in the chamber, such that the drops are reacting at different times and hence duration before they are analyzed.

Analysis

The samples need not be transferred to conventional types of chemical vials or multi-well plates for most types of analysis. Many types of chemical assays can be performed directly on the chemical reaction products as they moved via the moving surface. Non-destructive spectroscopic methods such as fluorescence, phosphorescence, fluorescence polarization, Raman, nuclear magnetic resonance (NMR) and absorption spectroscopy can be performed on the samples as they are moved to appropriate positions for the assays to be performed. In various embodiments of the invention, the droplet is hung from the moving surface while being analyzed, the droplet adhering to the moving surface through, at least in part, surface tension. In a preferred embodiment, a spectrometric analysis technique, such as mass spectrometry, can be performed by removing aliquots of the sample at specific points via the moving surface. The ability to translocate the sample using the moving surface allows for multiple types of spectroscopic and/or spectrometric assays to be performed on each sample in a sequential manner. Multiple designs for delivering a sample from a moving surface to an analyzer, such as a mass spectrometer, are possible. These may include, but are not limited to, the following approaches.

Standard Fluidic Systems

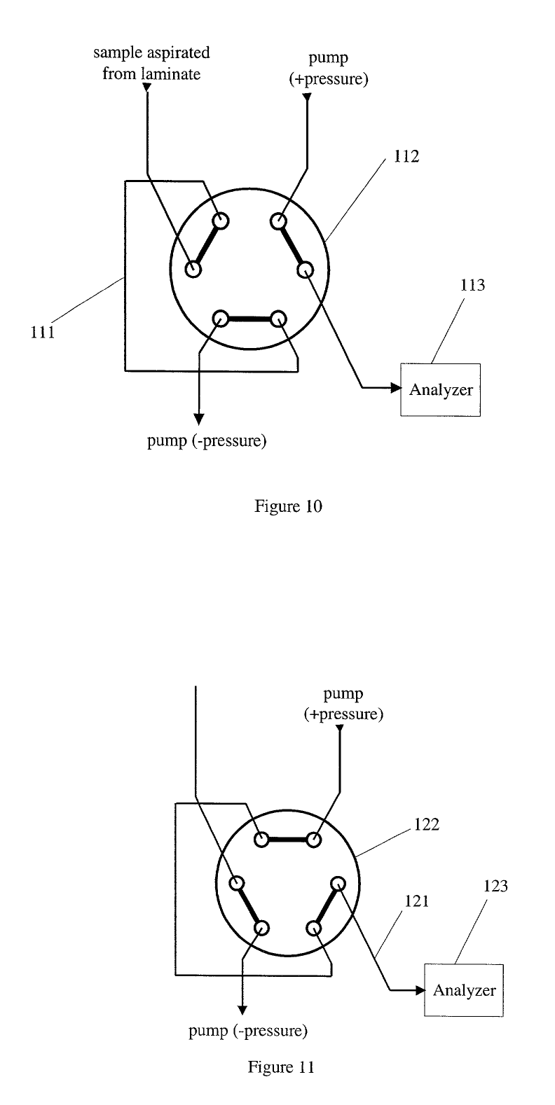

FIG. 9 is a schematic diagram of a valve assembly 107 that removes the sample 102 to be interrogated from the moving surface 101 by aspiration, in accordance with one embodiment of the invention. The sample 102 to be interrogated is removed from moving surface 101 by aspirating it off of the moving surface 101 through a length of narrow-bore capillary tubing 104. The sample is then directed to a valve 106. The actuation of this valve 106 will deliver the sample to an analyzer 105, such as a mass spectrometer. Initially the sample is aspirated into the valve 112 as shown in FIG. 10. Enough of the sample to fill a length of tubing 112 with a defined volume is aspirated. Upon actuation of the valve 122, this metered amount of the sample is directed through a narrow bore capillary 121 to the analyzer 123, such as a mass spectrometer, as shown in FIG. 11. The sample may be presented to the analyzer 123 using a variety of standard systems, including atmospheric pressure chemical ionization (APCI) or electrospray ionization (ESI).

Additional sample preparation steps may be performed while the droplet is in the valve. Prior to delivery to the analyzer the sample can be presented to a matrix of one or more types of immobilized or insoluble resins, beads, polymers, or particles with or without surface coatings for the removal of salts or other contaminants. The removal of contaminants with such a system can occur by the selective adsorption of the undesirable contaminants with the analyte of interest not being adsorbed and presented to the mass spectrometer. In an alternative embodiment of the invention, the sample is selectively adsorbed to the matrix under one set of conditions but is desorbed from the matrix under another set of conditions. The cleanup procedure could take place before, within, or after the valve assembly.

Piezo-electric Dispensing Units

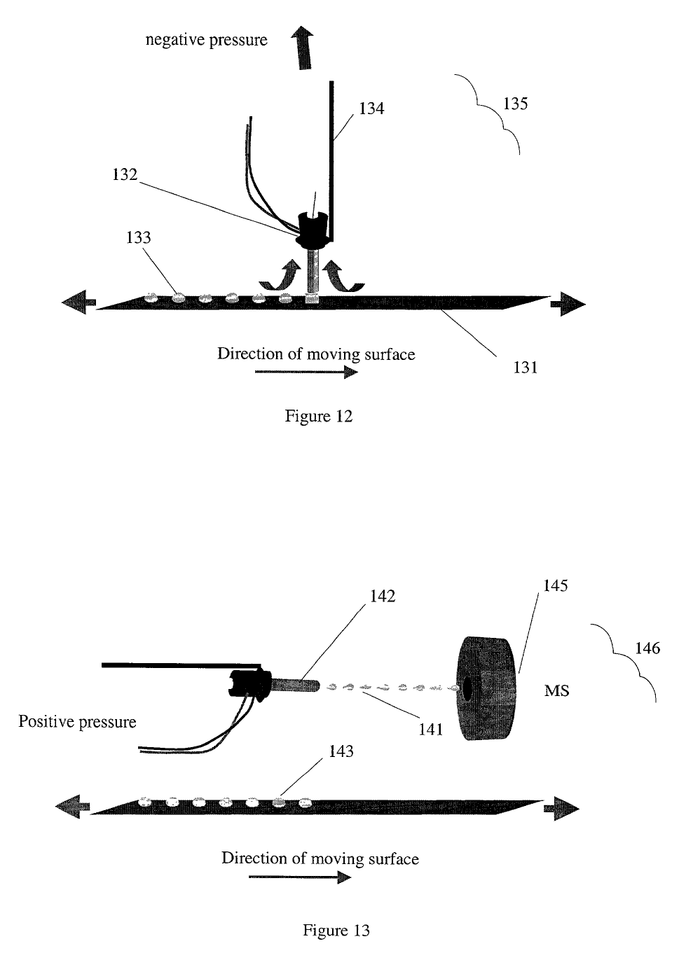

FIG. 12 is a schematic diagram of a piezo-electric unit assembly 135 that removes the sample 133 to be interrogated from the moving surface 131 by aspiration, in accordance with one embodiment of the invention. If desired, the sample 133 to be aspirated can be desalted or purified of contaminants prior to aspiration into a piezo-electric unit 132, which may be positioned by a position arm 134. Sample 133 to be interrogated is then dispensed from piezo-electric unit 132 and analyzed, for example, by a mass spectrometer. The piezo-electric system 146 could dispense the sample 143 in a stream of very small droplets 141, as shown in FIG. 13, similar to atomization that takes place in standard electrospray ionization mass spectrometry (ESI-MS). By adjusting the geometry of the stream of droplets 141, the MS inlet 145 temperature, and the flow rate and geometry of the sheath gas enough solvent can be evaporated from the micro-droplets 141 for direct analysis of the resulting ions by mass spectrometry.

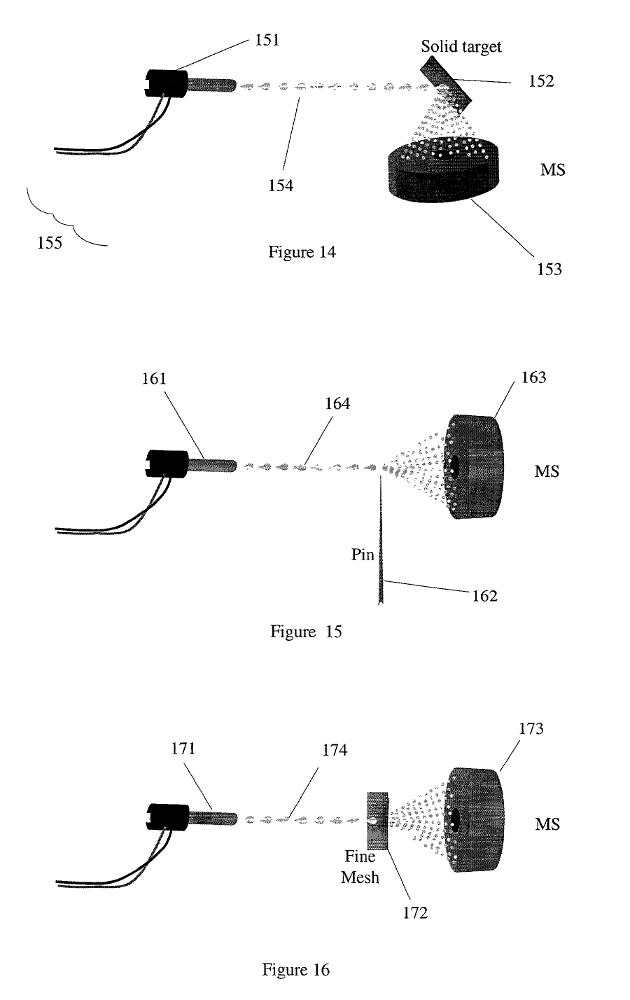

In an alternative embodiment of the invention, a piezo-electric unit 151 can deliver the sample in the form of a stream of micro-droplets 154 to a surface 152 proximal to the inlet orifice 153 of the mass spectrometer, as shown in the piezo-electric system 155 depicted in FIG. 14. The resulting atomization that takes place because of the splashing of a droplet after a high-speed collision with a surface is similar to that in ESI-MS. The surface to which sample stream 154 is directed could be coated with a variety of hydrophobic or hydrophilic coatings, its position and geometry could be optimized and an electric charge can be applied to the surface and the surface can be heated to assist in the optimal sample ionization and atomization for delivery to the mass spectrometer. The geometry of sample stream 154, inlet 153 temperature, and the flow rate and geometry of the sheath gas can also be optimized. In another embodiment, a piezo-electric unit 161 can deliver a sample in the form of a stream of micro-droplets 164 at the point of a sharp pin or needle 162 that is in proximity to the inlet orifice 1653 of the mass spectrometer, as shown in FIG. 15. Alternatively, the piezo-electric unit 171 can deliver a sample in the form of a stream of micro-droplets 164 to a fine mesh in proximity to the inlet orifice 1653 of the mass spectrometer, as shown in FIG. 16. The micro-droplets will further atomize upon hitting this surface and further disperse into an atomizing spray, similar to that in most atmospheric pressure ionization schemes currently used. The geometry and shape of the needle or pin with respect to the MS inlet orifice or the sample stream can be optimized to provide the largest amount of atomization. The surface of the pin or needle can be coated with a hydrophobic or hydrophilic surface and a voltage can be applied to the pin to optimize the atomization process. Additionally, a gas such as methane or ammonia can be introduced to the atomization chamber to perform a chemical ionization.

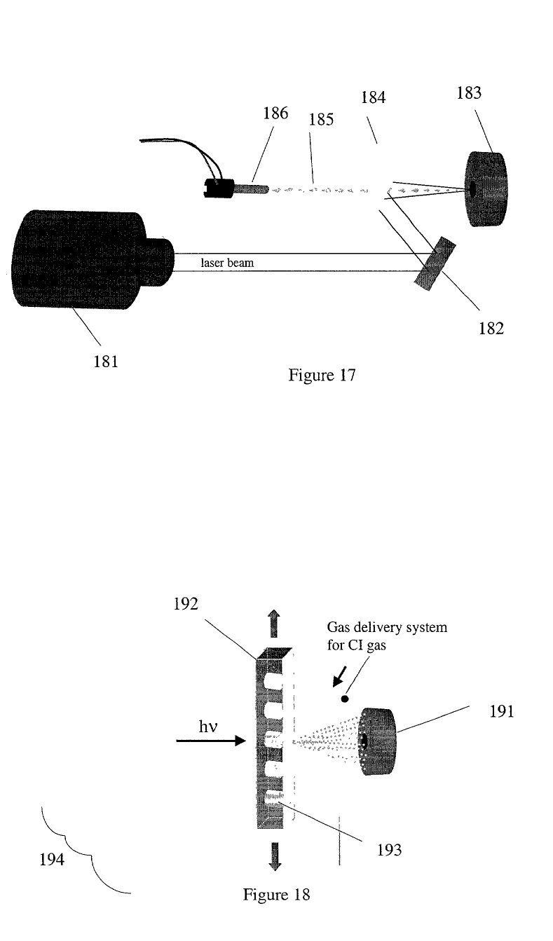

In another embodiment of the invention, the droplet stream 185 from the piezo-electric unit 186 can be directed through a hole in the center of a parabolic mirror 184 towards the inlet orifice 183 of the mass spectrometer, as shown in FIG. 17. A laser beam from a laser 181 is directed at and reflected from the mirror 182 so that the light beam is collinear with the droplet beam. Laser 181 wavelength is chosen for optimal absorption by the solvent to cause evaporation, and a long interaction length between drop stream 185 and the laser beam allows the use of a low power laser 181. Optimization of the laser power, wavelength and characteristics of piezo-electric droplet dispensing can allow for a complete evaporation of solvent from the droplets 185. Sample ionization may be achieved by applying an electrical potential to the gold plated parabolic mirror 184 through which the droplets 185 are fired. Alternatively, an atmospheric pressure chemical ionization scheme can be used to ionize samples.

Rapid Heating

FIG. 18 is a schematic diagram of a system 194 for rapidly heating samples on a moving surface 192 so as to cause atomization, in accordance with one embodiment of the invention. A sample is atomized and directed at the inlet orifice 191 of an analyzer by rapidly heating a small amount of the sample in an enclosed volume 193 with a narrow channel from which it can be released. The sample reservoir 193 may either be incorporated directly into the belt itself, or the samples could be transferred from the belt into reservoirs on a separate instrument. The geometry and structure of the exit channel from the sample reservoir 193 can be designed such that upon rapid heating of the reservoir the natural expansion of the sample cause it to be ejected from the reservoir through the orifice in the form of an atomized spray. This spray is analogous to ESI-MS and can be directed at the inlet orifice of the mass spectrometer. The geometry and shape of the reservoir 193 and exit channel with respect to the MS inlet orifice 191, the mass spectrometer inlet temperature, and the flow rate and character of the sheath gas can be optimized to provide the largest amount of atomization. Sample ionization can be accomplished by chemical ionization by increasing the partial pressure of a gas such as methane or ammonia near the atomized sample and by introducing the gas and sample to a corona discharge needle. This approach is similar to that used in atmospheric pressure chemical ionization (APCI-MS) schemes.

The heating of the reservoir can be accomplished either thermoelectrically or by focusing a laser beam inside the sample within the reservoir.

Pneumatic or Explosive Force

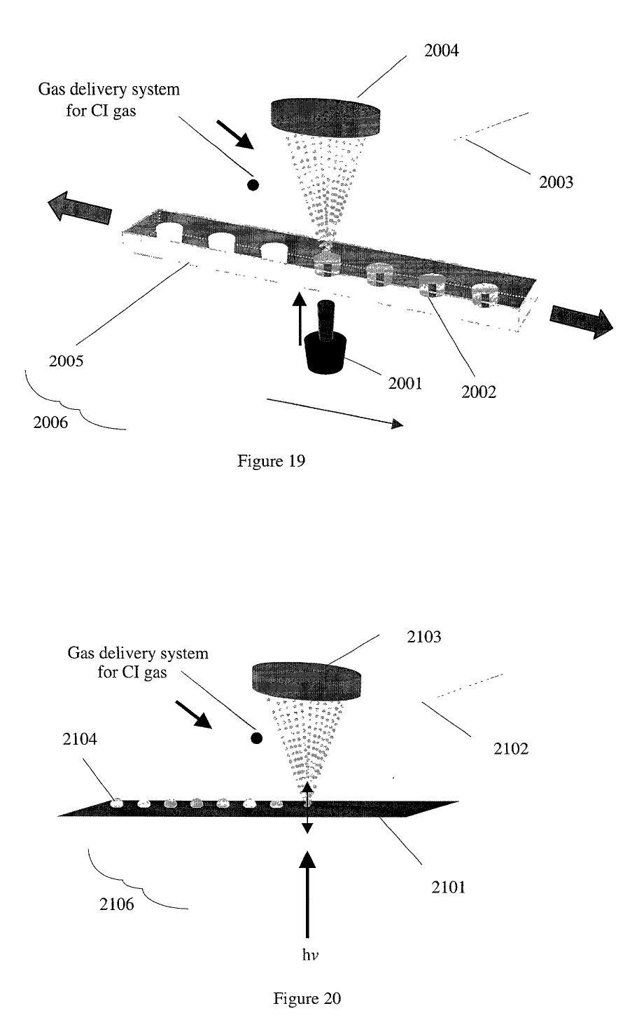

FIG. 19 is a schematic diagram of a system 2006 for forcibly ejecting a sample from a moving surface 2005, in accordance with one embodiment of the invention. A sample is placed within a reservoir 2002 with the appropriate geometry such that if forcefully ejected from reservoir 2002 the sample will atomize into a fine spray. If desired, the sample can be ejected from the reservoir through a narrow channel to increase the amount of sample that is atomized. Reservoirs 2002 may either be built directly into moving surface 2005 or samples can be transferred from moving surface 2005 to a separate instrument containing reservoirs 2002. Reservoir 2002 is positioned with a geometry such that when the sample is ejected from reservoir 2002 it is atomized and directed at the analyzer, for example, at the inlet orifice 2004 of the mass spectrometer. Reservoir 2002 may be shaped such that the atomization process is optimized. The sample may either be ejected with the use of a small explosive charge or by a pneumatic piston 2001 that actuates and applies pressure on the bottom of reservoir 2002. The geometry and shape of reservoir 2002 and exit channel with respect to the MS inlet orifice, mass spectrometer inlet 2004 temperature, and the flow rate and character of the sheath gas may be optimized to provide the desired amount of sample atomization and MS signal. Ionization of the sample may be performed by the use of an ionization gas such as methane or ammonia and a corona discharge needle 2003 similar to APCI-MS.

Vibration

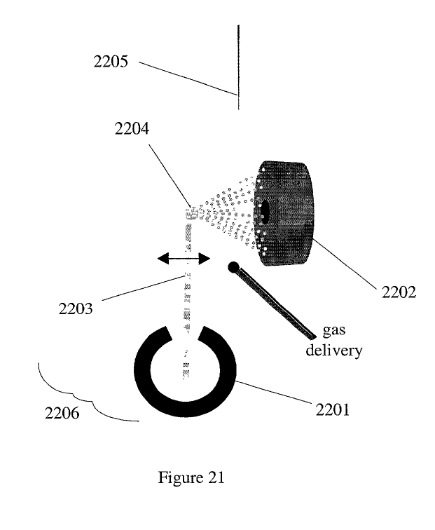

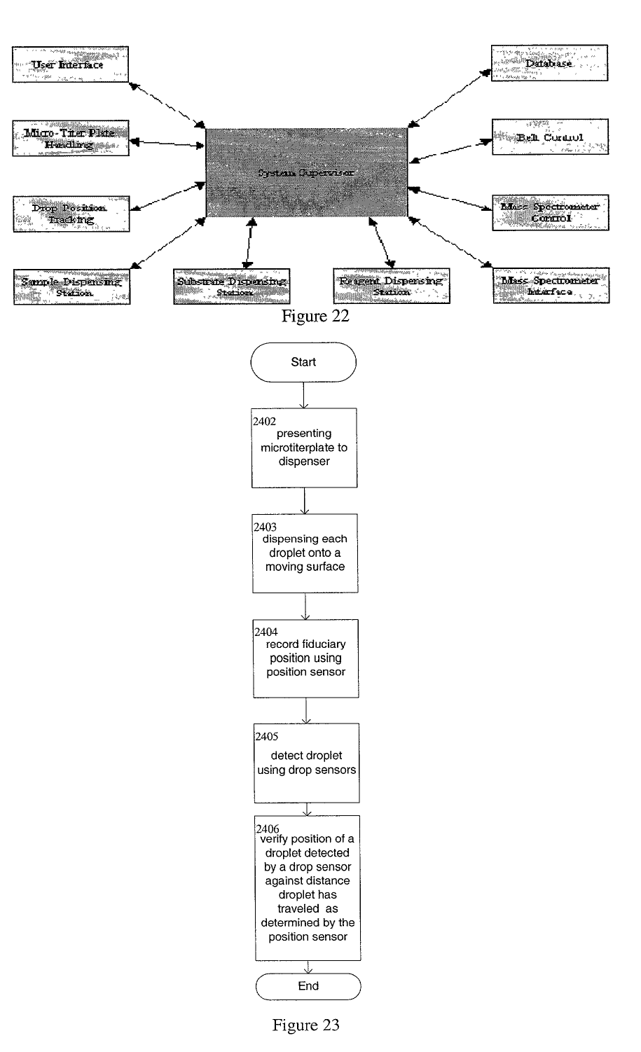

FIG. 20 is a schematic diagram of a system 2106 for rapidly vibrating samples on a moving surface 2101 so as to cause atomization, in accordance with one embodiment of the invention. A liquid sample 2104 deposited on a thin surface 2101 is atomized by rapid vibration of that surface 2101. The surface 2101 onto which the sample is deposited may be a thin film, such as the moving surface itself, or alternatively, the sample can be transferred to a suitable surface such as a thin film with a surface coating, a narrow flexible strip, or the point of a pin or needle. The rapid vibration of the sample 2104 may be performed by focusing a pulsed laser onto the surface near the sample 2104, or onto the backside of the surface onto which the sample has been deposited. Alternatively, acoustic systems using ultrasonic waves or a rapid mechanical system can be used to generate vibration. The sample may also be made to vibrate by using an alternating current 2201 to cause a probe 2203 onto which the sample 2204 has been deposited to move rapidly back and forth, as shown in FIG. 21. In this embodiment, the vibrating device 2206 is similar to the probe of an atomic force microscope (AFM), where the sample is deposited onto the tip of a probe similar to that of an AFM and rapid vibration of the probe results in atomization of that sample. In accordance with various embodiments of the invention, the surface onto which the sample is deposited can be made hydrophilic or hydrophobic, and the temperature of the surface and mass spectrometer inlet 2103, 2202 and the geometry and flow rate of the sheath gas can be optimized to provide the best sample atomization. Additionally, a voltage may be applied to the surface onto which the sample is deposited to assist in the formation of an appropriate spray for mass spectrometer interfacing. If desired, ionization of the sample can be performed by the use of a chemical ionization gas such as methane or ammonia and a corona discharge needle 2102, 2205 similar to APCI-MS.

High Throughput Screening Software Architecture

In accordance with one embodiment of the invention, the high throughput processing system architecture may be conceptually divided into two basic functional layers organized as a hierarchical relationship between subordinate task orientated components and a supervisory component which manages the coordination of the subordinate tasks, as shown in FIG. 22. In FIG. 22, relationships between the system architecture elements are shown with lines indicating the flow of data between elements. Each component represents an independently running thread of execution or an entirely separate process, which may run on separate processors where desired. This is an important characteristic that is emphasized in order to highlight the flexibility and reliability of the system. For example, the system allows the selective application of real-time processing computing platforms where they are required without burdening other system elements that do not have real-time requirements with the added complexity and costs associated with real-time processing.

The architecture maximizes the functional capabilities and flexibility of the high throughput system by allowing swift and smooth integration of new or reconfigured electromechanical configurations to the system while at the same time ensuring that overall, the system is not globally effected by the changes in sub-system designs. Additionally, the architecture enhances system reliability by condensing the various system aspects into independent islands of functionality that may monitor and report their own progress to the supervisory layer. The supervisory layer can then coordinate the overall system operation based on the state of the lower layers without being burdened with unnecessary information. Each layer may be conceptually reduced to a finite state machine with well-defined states and transitions thus achieving the robust and deterministic behavior required. This segregation also improves system reliability by ensuring that errors occurring in low level sub-systems do not corrupt the entire throughput process. The supervisory layer can observe such failures and various corrective actions initiated or in the most extreme cases, operation may be gracefully shutdown while appropriate status reports are generated for the human operators.

System components may include a conveyer belt, sample, substrate and reagent dispensing stations, a microtiter plate handling system, an analyzer interface, an analyzer control system, a database of sample information, a droplet tracking system, a supervisor system, and a user interface. Examples of each of these components follow.

The conveyor belt may include a narrow and long regularly cogged timing belt, a system of pulleys and tensioning elements, a stepper motor for actuation, and a rotary encoder for feedback. The belt is commanded to maintain a constant velocity during system operation. The encoder is attached to an idler pulley and provides motion state feedback of the belt. Using this encoder the velocity of the belt can be accurately recorded, belt failures or stalls detected, and individual drop positions within the system may be tracked. The rotary encoder tracking belt motion serves as the primary source of synchronization for the various subsystems making up the throughput processing system. Since there is a fixed distance measured along the length of the belt between any two actively controlled system elements that perform an operation on a given drop, the belt encoder provides the most accurate and dependable method for triggering such operations and in preferred embodiments of the invention serves as the primary method of system synchronization.

A sample library dispensing station may include a multi-axis positioning system actuated by micro-stepper motors outfitted with high-resolution linear encoders to ensure accurate positioning of each axis. The dispensing station moves an array of micro-syringes to the microtiter plate holding the sample to be analyzed, withdraws a volume of sample using an array of micro-syringes and finally dispenses the drops onto the surface of the moving belt. The sample dispensing station is required to keep pace with the desired drop throughput rate by retrieving samples from particular wells of the microtiter plate sample and placing them onto the conveyor belt.

The substrate and reagent dispensing stations may include a micro-valve(s) for dispensing those fluids and a drop sensing system. These stations wait for a sample drop to arrive, which may be directly sensed using an optical, capacitive or magnetic-based sensor whereupon the valve is actuated adding substrate or reactant to the sample drop. The presence of particular drops placed by the sample dispensing station are thus verified and missing drops are reported. In one embodiment of the invention, a substrate-dispensing valve is placed at the beginning of the belt, which will dispense drops at regularly spaced intervals as triggered by the belt encoder. This ensures that the drops will be accurately spaced on the belt, which is crucial to proper system operation.

The microtiter plate handling system may include a plate retrieval and stacking robotic system which presents plates of samples to be screened to the dispensing station and removes the plates when no longer needed. Such a system may be software controlled. Additionally, if the plates are equipped with bar codes a bar code scanner may be integrated into the plate handler and used to automate plate identification.

The analyzer interface system may include a drop sensor and a multi-port fluidic valve that introduces samples to the analyzer. The drop sensor detects the presence of the drop ahead of the input tubing to the multi-port valve. After the drop has been moved by the belt under the tubing orifice, the valve is actuated by a signal from the computer and the drop is drawn into the tube by negative pressure. A second signal from the computer actuates the valve to inject the sampled drop into the input of the analyzer.

The analyzer control system may include a routine that manages all communications between the throughput system and the analyzer as well as the configuration of the analyzer at run time. This task involves configuring the analyzer appropriately given the sample drops being fed into it and controlling how data is generated and recorded by the device. Configuration changes may include changing the sensitivity of the device, or creating a series of data files recording the results of the scans for example.

A database of sample information may be created for each screening process in which screening data pertaining to uniquely identified drops is recorded for analysis. Examples of information likely to be recorded include chemical information about the compounds in the library, substrate and reactants added, and analyzer results.

In various embodiments of the invention, the supervisory task receives high-level commands from the operator interface and manages the automated screening process. The supervisory task may control the execution of the other system tasks, such as the belt task, or the dispensing control tasks, by being responsible for the starting and stopping of these tasks, and querying them for information about their current state. Each sub task may have a finite number of possible execution states, which may be regulated by the supervisor task. A simple table may be maintained by the supervisor task that describes the entire state of the high throughput processing, which may be updated by querying the various sub tasks at some regular interval. Each sub-task managed by the supervisor maintains a data structure accessible in some way by the supervisor task, which will serve as the source of the information for the supervisor task's global state table. The contents of the global state table maintained by the supervisor task in turn dictate what controlling actions should be initiated by it. After querying each sub task for an update on their respective state data, the supervisor task examines the new information and initiates a reflexive response action if so dictated by the new information. For example, after querying the sub tasks the belt task's state indicates that the belt has become stuck for some reason. This condition would be discovered by the belt encoder failing to increment, a condition which would be noted by the belt task and the belt task state updated appropriately. This fatal error condition would initiate a preprogrammed response by the supervisor task, which would then effect a controlled but immediate shut down of the screening process and an alarm message generated for the user interface.

Accurate identification and droplet tracking of a particular sample droplet as it passes through the system can be advantageously incorporated into the high throughput processing system. The droplet tracking system may include a run time database that maintains a data-structure updated at a regular and constant rate which tracks the position of all drops as they pass through the system. Based on this tracking, information about particular drops can be forwarded to, and may act as a trigger for, other system elements that perform some operation on particular drops when they arrive at particular positions along the belt. For example, the drop tracker may be responsible for triggering the reagent dispensing task to expect a certain drop and to perform its sensing/verification of the drop as well as adding the reagent to that drop.

FIG. 23 is a flowchart showing an example of how a droplet can be tracked, in accordance with one embodiment of the invention. At system start up, the operator provides data on the microtiter plates containing the samples to be analyzed during the screening, step 2401. In various embodiments, each plate has a unique id and the wells on each plate have a unique address. For example, the number 3445-7-8 would uniquely identify a drop from the well at the 7^{th} row, 8^{th} column of plate 3445. The microtiter plate may be fitted with a bar code sticker and a bar code reader could be integrated into the throughput system to automate the process of identifying individual plates.

The microtiter plate handling subsystem is then commanded to retrieve and present to the sample dispensing station a particular plate 2402. Once this is accomplished, the dispensing station is commanded to retrieve and place on the belt a particular row of samples from the plate, step 2403, and the exact position of the drop on the belt is recorded, as reported by a position sensor, which may be a rotary encoder, step 2404. In this manner, a fiduciary position for each droplet on the belt is obtained, which may be saved to random-access memory. Particular droplets are then tracked using drop sensors as they pass through the system, step 2405. The drop sensors are located at known positions relative to the position sensor. Positions of particular droplets detected by the drop sensor(s) can thus be verified against the requisite distance traveled by each droplet as determined by the position sensor, step 2406. If the sensor fails to register an expected droplet the failure is recorded by the supervisory layer and the droplet is appropriately marked in the data tracking system. Drop sensors may be located at substrate and reactant stations, for example. Additionally, this sensing and recording process may be repeated at the analyzer interface as well. A similar drop-sensing device may also verify the existence of a particular and uniquely identified drop as it is fed to the analyzer. Taken together, the belt position sensor (rotary encoder), and the three drop sensors provide a redundant drop tracking and verification system. Data retrieved from the analyzer may then be correlated with the drop tracking data recorded by the throughput subsystem by recording the belt position of each drops introduction into the analyzer via the analyzer interface.

Additionally, reactants with known analyzer properties may be inserted at known locations in each microtiter plate to aid in tracking and de-bugging of errors that may occur during the assay process. For example, in screening for inhibitors, some wells in the microtiter plates will either contain no inhibitors (e.g buffer only) or a known inhibitor of the enzyme(s) under study. Measurement of these known cases will serve to detect errors in the fluidic handling or drop tracking sub-system.

In accordance with one embodiment of the invention, the user interface may be a graphical interface presented to an operator on a standard desktop that is running a windows based operating system. Alternatively, the user interface may be a command line based system. The interface may allow configuration of a screening process which, in some cases, may last up to 10 hours or more. In order to accomplish this the interface must allow a user/operator to enter into the system various types of data, including, but not limited to: how many microtiter plates to retrieve and process; which rows of samples to retrieve from the plate and input to the screening system; names for the data file(s) that are to be generated; and configuration settings for the analyzer, which may include specifying a per sample or per plate granularity.

In an alternative embodiment, the disclosed method may be implemented as a computer program product for use with a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A method for high throughput processing of a plurality of droplets, the method comprising:
a) dispensing the plurality of droplets onto a substantially unperforated surface; and
b) moving the surface through a delay line such that each droplet hangs from the surface for at least a specified minimum period of time, the droplet adhering to the surface by virtue, at least in part, of surface attraction.

2. A method according to claim 1, wherein the step of dispensing droplets includes limiting each droplet to a specified volume smaller than one microliter.

3. A method according to claim 1, wherein dispensing each droplet onto the surface includes dispensing each droplet while the surface is moving.

4. A method according to claim 1, wherein moving the surface through a delay line includes moving the surface via a pulley system.

5. A method according to claim 1, wherein moving the surface through a delay line includes moving the surface around a drum.

6. A method according to claim 1, wherein moving the surface through the delay line includes hanging each droplet beneath the surface.

7. A method according to claim 1, wherein moving the surface through the delay line includes exposing each droplet to a controlled environment.

8. A method according to claim 1, further comprising a step of analyzing a characteristic of each droplet.

9. A method of high throughput processing of a plurality of droplets, the method comprising:
a) dispensing each droplet onto a moving surface; and
b) tracking each droplet's position.

10. A method according to claim 9, wherein the moving surface moves continuously.

11. A method according to claim 9, wherein the moving surface moves in a discontinuous start/stop action.

12. A method according to claim 9, wherein dispensing the droplet onto the moving surface includes:
a) providing one or more microtiter plates to a microtiter plate handling system;
b) providing data that identifies each microtiter plate's position to the microtiter plate handling system;
c) commanding the microtiter plate handling system to retrieve a particular microtiter plate; and
d) presenting a particular plate for dispensing.

13. A method according to claim 9, wherein tracking each droplet's position includes measuring and recording each droplet's position on the moving surface using a position sensor, such that each droplet is associated with a fiducial position on the moving surface.

14. A method according to claim 13 wherein the position sensor is a rotary encoder.

15. A method according to claim 13, wherein the steps of measuring and recording occur at substantially the same time each droplet is dispensed onto the moving surface.

16. A method according to claim 13, wherein recording each droplet's position includes saving each droplet's position in random-access memory.

17. A method according to claim 13, wherein tracking each droplet's position includes:
a) detecting each droplet using a drop sensor, the drop sensor at a known position relative to the position sensor; and
b) verifying that the known position corresponds to each droplet's position based on the fiducial position and position information obtained from the position sensor at each droplet's time of detection.

18. A method according to claim 17, wherein the drop sensor is located at an interface to an analyzer.

19. A method according to claim 17, wherein the drop sensor is located at a substrate station.

20. A method according to claim 17, wherein the drop sensor is located at a reactant station.

21. A method according to claim 17, further comprising:
a) recording a failure if the known position does not correspond to each droplet's position based on the fiducial position and position information obtained from the position sensor at time of detection.

22. A method according to claim 9, wherein tracking each droplet's position includes using a drop sensor to detect each droplet.

23. A method according to claim 13, further comprising:
a) dispensing a particular droplet with known analytical properties onto the moving surface; and
b) verifying position and identity of the particular droplet, wherein verifying includes:
i) analyzing the particular droplet at a known position relative to the fiducial position so as to obtain analyzed properties,
ii) comparing the particular droplet's analyzed properties with the particular droplet's known analytical properties,
iii) comparing the known position against the particular droplet's position as derived from the position sensor.

24. A method according to claim 9 further comprising subjecting each droplet to a controlled environment.

25. A method according to claim 24, wherein subjecting each droplet to a controlled environment includes hanging each droplet from the moving surface for at least some period of time, each droplet adhering to the moving surface through, at least in part, surface attraction.

26. A method according to claim 24, further comprising transporting each droplet, via the moving surface, through an environmentally controlled delay line.

27. A method according to claim 9, further comprising performing at least one operation on each droplet from the group of operations consisting of mixing, diluting, concentrating, filtering, and analyzing.

28. A method according to claim 27, wherein analyzing includes performing at least one operation from the group of operations consisting of optical interrogation and mass spectrometry.

29. A method according to claim 28, wherein optical interrogation includes at least one of fluorescence spectrometry, Raman spectroscopy and UV absorption.

30. A method according to claim 27, wherein analyzing the content of each droplet includes:
a) aspirating each droplet into a dispensing unit; and
b) presenting each droplet for analysis via the dispensing unit.

31. A method according to claim 30, wherein presenting each droplet for analysis includes:
a) presenting each droplet to a mass spectrometer; and
b) determining a characteristic of each droplet by means of mass spectrometry.

32. A method according to claim 27, wherein analyzing a characteristic of each droplet includes:
a) heating each droplet so as to form an atomized spray; and
b) determining a characteristic each droplet by means of mass spectrometry.

33. A method according to claim 27, wherein analyzing a characteristic of each droplet includes:
a) applying a pneumatic force to each droplet so as to form an atomized spray; and
b) determining a characteristic of each droplet by means of mass spectrometry.

34. A method according to claim 27, wherein analyzing a characteristic of each droplet includes:
a) applying an explosive force to each droplet so as to form an atomized spray; and
b) determining a characteristic of each droplet by means of mass spectrometry.

35. A method according to claim 27, wherein analyzing a characteristic of each droplet includes:
a) vibrating each droplet so as to cause atomization; and
b) determining a characteristic of each droplet by means of mass spectrometry.

36. A method according to claim 35, wherein vibrating the droplet includes focusing a pulsed laser onto the surface in a proximity of each droplet.

37. A method according to claim 35, wherein vibrating each droplet includes focusing a pulsed laser onto the backside of the surface onto which each droplet has been deposited.

38. A method according to claim 35, wherein vibrating each droplet includes utilizing acoustic waves.

39. A method according to claim 35, wherein vibrating each droplet includes mechanically vibrating the surface.

40. A method according to claim 35, further comprising applying a voltage to the surface onto which each droplet is deposited to assist in the formation of atomized spray.

41. A method according to claim 9, further comprising spooling a laminate onto the moving surface prior to dispensing each droplet onto the moving surface.

42. A method according to claim 41, further comprising spooling the laminate off of the moving surface after performing at least one operation on each droplet.

43. A method according to claim 41, further comprising customizing at least one surface property of the laminate from the group of surface properties consisting of cleanliness, biocompatibility, surface energy, binding affinity, porosity, chemical interaction, chemical addition, sample information encoding, and tracking.

44. A method according to claim 9, wherein the step of dispensing includes limiting each droplet to a specified volume smaller than one microliter.

45. A method of high throughput processing of a plurality of droplets, the method comprising:
a) hanging each droplet from a dispenser;
b) bringing each droplet into momentary contact with a moving surface having a probe, such that each droplet is deposited onto the probe through surface attraction;
c) applying an alternating current to the probe so as to cause the probe to vibrate such that each droplet is atomized; and
d) analyzing a characteristic of each droplet.

46. A method of high throughput processing of a plurality of droplets, the method comprising:
a) dispensing each droplet into an enclosed volume, the enclosed volume having an exit channel, the enclosed volume incorporated into a moving conveyer;
b) heating each droplet in the enclosed volume such that the expansion of the droplet causes it to be ejected through the exit channel in the form of an atomized spray; and
c) analyzing a characteristic of the atomized spray by means of mass spectrometry.

47. A method for high throughput processing of a plurality of droplets, the method comprising:
a) spooling a laminate onto a moving surface;
b) dispensing each droplet onto the laminate; and
c) performing on each droplet at least one operation from the group of operations consisting of mixing, diluting, concentration, heating, cooling, humidifying, filtering, and analyzing.

48. A method according to claim 47 wherein the step of spooling includes depositing the laminate onto a conveyor belt.

49. A method according to claim 48, further comprising spooling the laminate off the moving surface.

50. A method according to claim 49, further comprising:
a) cleaning the laminate; and
b) repeating the steps of spooling the laminate onto the moving surface, dispensing, performing on each droplet at least one operation, and spooling the laminate off the moving surface.

51. A method according to claim 49, further comprising disposing the laminate.

52. A method according to claim 47, further comprising customizing at least one surface property of the laminate from the group of surface properties consisting of cleanliness, biocompatibility, surface energy, binding affinity, porosity, chemical interaction, chemical addition, sample information encoding, and tracking.

53. A method according to claim 47, wherein the laminate is magnetic and the droplet includes magnetized particles.

54. A method according to claim 47, further comprising subjecting each droplet to a controlled environment.

55. A method according to claim 54, wherein subjecting the at least one droplet to a controlled environment includes hanging the droplet from the laminate for at least a specified minimum period of time, the droplet adhering to the laminate through, at least in part, surface tension.

56. A method according to claim 54, further comprising transporting the droplet on the laminate, by virtue of motion of the movable surface, through an environmentally controlled delay line prior to performing the at least one operation on each droplet.

57. A method according to claim 47, wherein the moving surface moves continuously.

58. A method according to claim 47, wherein the moving surface moves in a discontinuous start/stop action.

59. A method according to claim 47, wherein analyzing includes performing at least one operation from the group of operations consisting of optical interrogation and mass spectrometry.

60. A method according to claim 59, wherein the step of analyzing includes applying at least one of fluorescence spectrometry, Raman spectroscopy and UV absorption.

61. A method according to claim 59, wherein analyzing includes hanging each droplet from the laminate for at least some period of time, the droplet adhering to the laminate through, at least in part, surface tension.

62. A method according to claim 47, further comprising tracking each droplet on the moving surface.

63. A method according to claim 62, wherein tracking each droplet includes using at least one sensor from the group of sensors consisting of a position sensor and a drop sensor.

64. A system for high throughput processing of a plurality of droplets, the system comprising:
a) a movable surface that is substantially unperforated;
b) a dispenser for dispensing each droplet onto the surface; and
c) a delay line for moving the surface such that the each droplet hangs from the surface for at least a specified minimum period of time, the droplet adhering to the surface by virtue, at least in part, of surface attraction.

65. A system according to claim 64, wherein each droplet has a volume smaller than one microliter.

66. A system according to claim 64, wherein the movable surface moves continuously.

67. A system according to claim 64, wherein the movable surface moves in a discontinuous start/stop action.

68. A system according to claim 64, wherein the delay line includes a pulley system such that the surface moves back and forth in a confined area.

69. A system according to claim 64, wherein the delay line includes a drum that rotates, such that the surface travels around the drum in a confined area.

70. A system according to claim 64, wherein the delay line includes an environmental chamber, for subjecting the droplet dispensed on the surface to a controlled environment.

71. A system according to claim 64, wherein the surface has at least one customized surface property from the group of surface properties consisting of cleanliness, biocompatibility, surface energy, binding affinity, porosity, chemical interaction, chemical addition, sample information encoding, and tracking.

72. A system according to claim 64, further including an analyzer, for analyzing a characteristic of each droplet.

73. A system according to claim 72, wherein the analyzer is a mass spectrometer.

74. A system according to claim 64, wherein the moving surface is a conveyor belt.

75. A system according to claim 64, further comprising a laminate that is spooled onto the moving surface, such that the droplet is dispensed onto the laminate.

76. A system of high throughput processing of a plurality of droplets, the system comprising:
a) a moving surface;
b) a dispenser for dispensing each droplet onto the moving surface; and
c) a tracking system for tracking each droplet's position.

77. A system according to claim 76, wherein the moving surface moves continuously.

78. A system according to claim 76, wherein the moving surface moves in a discontinuous start/stop motion.

79. A system according to claim 76, further including a microtiter plate handling system for receiving data identifying at least one micotiter plate, retrieving a particular microtiter plate based on a received command, and presenting the particular plate for dispensing.

80. A system according to claim 76, wherein the tracking system includes a recorder, for measuring and recording information pertaining to each droplet's position on the moving surface.

81. A system according to claim 80, wherein the recorder includes random-access memory.

82. A system according to claim 76, wherein the tracking system includes a position sensor for associating each droplet with a fiducial position on the moving surface.

83. A system according to claim 82, wherein the position sensor is a rotary encoder.

84. A system according to claim 82, wherein the tracking system includes at least one drop sensor.

85. A system according to claim 84, wherein the at least one drop sensor is positioned at a known position such that upon the at least one drop sensor detecting each droplet, the known position can be verified against each droplet's fiducial position and position information obtained from the position sensor at each droplet's time of detection.

86. A system according to claim 85, wherein the at least one drop sensor is located at an interface to an analyzer.

87. A system according to claim 85, wherein the at least one drop sensor is located at a substrate station.

88. A system according to claim 85, wherein the at least one drop sensor is located at a reactant station.

89. A system according to claim 76, wherein the tracking system includes at least one drop sensor.

90. A system according to claim 76, further including an environmental chamber, for subjecting the droplet dispensed on the surface to a controlled environment.

91. A system according to claim 90, wherein the environmental chamber includes a delay line.

92. A system according to claim 91, wherein the delay line includes a pulley system such that the moving surface moves back and forth in a confined area.

93. A system according to claim 91, wherein the delay line includes a drum that rotates, such that the moving surface travels around the drum in a confined area.

94. A system according to claim 86, further including an analyzer for determining a characteristic of each droplet.

95. A system according to claim 94, further comprising an aspirator for aspirating each droplet into the dispensing unit, whereupon each droplet is presented to the analyzer via the dispensing unit.

96. A system according to claim 94, wherein the analyzer is a mass spectrometer.

97. A system according to claim 96, further including a means for rapidly heating each droplet so as to form an ionized spray.

98. A system according to claim 96, further including a laser for rapidly heating each droplet so as to form an ionized spray.

99. A system according to claim 96, further including a means for applying a pneumatic force to each droplet so as to form an atomized spray.

100. A system according to claim 96, further including a piston for applying a pneumatic force to each droplet so as to form an atomized spray.

101. A system according to claim 96, further including a means for applying an explosive force to each droplet so as to form an atomized spray.

102. A system according to claim 96, further including a means for vibrating each droplet so as to form an atomized spray.

103. A system according to claim 96, further including a pulsed laser for focusing onto the surface in a proximity of the droplet so as to vibrate the droplet and cause atomization.

104. A system according to claim 96, further including a probe for vibrating the droplet so as to cause atomization, the probe moving rapidly back and forth in response to an alternating current.

105. A system according to claim 94, wherein the analyzer includes means for an optical analyzer.

106. A system according to claim 76, wherein the moving surface is a conveyor belt.

107. A system according to claim 76, wherein the moving surface is a fiber.

108. A system according to claim 76, wherein the moving surface is a timing belt.

109. A system according to claim 76, wherein the moving surface is unperforated.

110. A system according to claim 76, further comprising a laminate which is spooled onto the moving surface, such that each droplet is dispensed onto the laminate.

111. A system according to claim 76, wherein the laminate has at least one customized surface property from the group of surface properties consisting of cleanliness, biocompatibility, surface energy, binding affinity, porosity, chemical interaction, chemical addition, sample information encoding, and tracking.

112. A system according to claim 76, wherein each droplet has a volume smaller than one microliter.

113. A system for high throughput processing of a plurality of droplets, the system comprising:
a) a moving surface;
b) a laminate spooled to the moving surface;
c) a dispenser, for dispensing each droplet onto the laminate; and
d) a means for performing on each droplet at least one operation from the group of operations consisting of mixing, diluting, concentrating, heating, cooling, humidifying, filtering, and analyzing.

114. A system according to claim 113 further including a first spool for spooling the laminate onto the moving surface.

115. A system according to claim 114 further including a second spool for spooling the laminate off of the moving surface.

116. A system according to claim 113, wherein the means for performing includes an environmental chamber, for subjecting each droplet dispensed on the laminate to a controlled environment.

117. A system according to claim 116, wherein the environmental chamber includes a delay line.

118. A system according to claim 117, wherein the controlled delay line includes an enclosed pulley system, such that the laminate travels back and forth in the environmental chamber.

119. A system according to claim 117, wherein the delay line includes a drum that rotates, such that the laminate travels around the drum in the environmental chamber.

120. A system according to claim 113, wherein the laminate has at least one customized surface property from the group of surface properties consisting of cleanliness, biocompatibility, surface energy, binding affinity, porosity, chemical interaction, chemical addition, sample information encoding, and tracking.

121. A system according to claim 113, wherein the laminate is magnetized.

122. A system according to claim 113, wherein the moving surface is a conveyor belt.

123. A system according to claim 113, wherein the moving surface is a timing belt.

124. A system according to claim 113, further including a drop sensor for detecting each droplet.

125. A system according to claim 113, wherein the moving surface moves continuously.

126. A system according to claim 113, wherein the moving surface moves in a discontinuous start/stop motion.

127. A system according to claim 113, wherein the laminate is unperforated.

128. A system according to claim 113, wherein the means for performing includes a mass spectrometer.

129. A method for high throughput processing of a plurality of droplets, the method comprising:
a) dispensing the plurality of droplets onto a substantially unperforated surface; and
b) moving the surface through a delay line such that each droplet hangs from the surface for at least a period of time, wherein the force acting to counter gravity is predominantly non-shearing.

130. A system for high throughput processing of a plurality of droplets, the system comprising:
a) a movable surface that is substantially unperforated;
b) a dispenser for dispensing each droplet onto the surface; and
c) a delay line such that each droplet hangs from the surface for a period of time, wherein the force acting to counter gravity is predominantly non-shearing.
